(19) United States
(12) Patent Application Publication
(10) Pub. No.: US 2008/0170388 A1
(43) Pub. Date: Jul. 17, 2008

(54) Cooler with a lid which contains a light that is activated as the lid is opened

(76) Inventor: Eric M. Greil, Shiocton, WI (US)

Correspondence Address: WILHELM LAW SERVICE, S.C., 100 W LAWRENCE ST, THIRD FLOOR, APPLETON, WI, 54911, US

(21) Appl. No.: 12/008,555

(22) Filed: Jan. 11, 2008

Related U.S. Application Data
(60) Provisional application No. 60/885,238, filed on Jan. 17, 2007.

(51) Int. Cl. F21V 33/00; B65D 81/38; F25D 23/00; F25D 27/00

(52) U.S. Cl. 362/155; 62/457.1; 220/592.2; 62/264

(57) ABSTRACT

A cooler is disclosed which includes a storage compartment having a predetermined volume capacity. A lid having an interior surface is connected to the storage compartment and is designed to pivot between a closed position and an open position. The open position is angled at least about 90 degrees from the closed position. A housing having an interior surface, an exterior surface and a void volume therebetween is secured to the interior surface of the lid. A printed circuit board is secured within the housing. The printed circuit board includes a power source, a tilt switch and an electrical circuit connected therebetween. A light is also connected to the electrical circuit and protrudes through the housing, wherein as the lid is raised a predetermined number of degrees from the closed position, the tilt switch causes the light to turn on to illuminate the storage compartment of the cooler.

### CROSS REFERENCE TO RELATED APPLICATION

This patent application is a regular patent application claiming priority to U.S. provisional patent Application 60/885,238.

### FIELD OF THE INVENTION

This invention relates to a cooler with a lid which contains a light that is activated as the lid is opened.

### BACKGROUND OF THE INVENTION

Today, coolers of various sizes and shapes are utilized to keep food and/or beverages cold. Such coolers have become an indispensible part of most camping trips, hunting and fishing expeditions, outdoor activities including concerts, sporting events, social gatherings, day trips, etc. Some coolers have gotten so large that they even include wheels to assist in their transport. Up until now, cooler have not contained an internal light source. A person, especially on a camping trip to a remote area and after dark, would have to hold a flashlight in one hand while hunting around with his or her other hand to obtain a desired object from the cooler. This was inconvenient and hindered recovery of the desired object especially when the object was small in size or was heavy and required two hands in order to retrieve it from the cooler. Since many coolers are utilized in outdoor activities where the light level may be low or absence, it has been determined that a light source integrally connected to the cooler would be very useful.

Another issue confronting placing a light source on or within a cooler is that coolers are usually used in environments where there is no access to electricity. Therefore, the light source needs it own power supply. A light source, such as a standard light bulb, powered by one or two C or D size alkaline batteries requires a fair amount of electrical power to operate over an extended period of time. The batteries are relatively heavy and add additional weight to the cooler. This is especially true for small coolers, such as those of a size designed to hold only a six pack of beer.

A third issue confronting coolers which rely on a standard light bulb connected to one or two alkaline batteries as the light source is that the batteries must be constantly replaced. It is well known that most standard alkaline batteries will lose their charge if they are not used for an extended period of time. This can become an inconvenience especially when the batteries are low on power or give out while the cooler is being used at an outdoor activity. In addition, many coolers are only utilized sparingly and are stored for long periods of nonuse. This means that the cooler may sit in a basement or a garage for months between uses. When the owner is ready to use the cooler the batteries may be dead. Furthermore, the owner of the cooler may not have the time or ability to buy new batteries and therefore the light source is inoperable.

Now, a cooler with a lid which contains a light has been invented and the light can operate on low electrical power and is activated and deactivated as the lid is opened or closed.

### SUMMARY OF THE INVENTION

Briefly, this invention relates to a cooler with a lid which contains a light that is activated as the lid is opened. The cooler is formed from an insulating material and has a storage compartment with a predetermined volume capacity. A lid is connected to the cooler and is designed to pivot between a closed position and an open position. In the closed position, the storage compartment is enclosed while in the open position the lid is angled at least about 90 degrees from the closed position and ingress and egress into and from the storage compartment is possible. The lid has an interior surface. A housing having an interior surface, an exterior surface and a void volume therebetween is secured to the interior surface of the lid. A printed circuit board is positioned in the void volume and is secured to the interior surface of the housing. The printed circuit board includes a power source, a tilt switch and an electrical circuit connecting the power source to the tilt switch. A light is also connected to the electrical circuit and protrudes through the exterior surface of the housing. As the lid is raised through a predetermined number of degrees from the closed position, the tilt switch causes the light to turn on to illuminate the storage compartment of the cooler. When the cooler is used in a dark environment, such as at night while on a camping trip, the light will illuminate the inside of the storage compartment such that a person can see what items are to be withdrawn or placed within the cooler.

The general object of this invention is to provide a cooler with a lid which contains a light that is activated as the lid is opened. A more specific object of this invention is to provide an insulated cooler that has a pivotable lid that can be raised or lower relative to the storage compartment and which contains a light which is activated and deactivated as the lid is raised or lowered.

Another object of this invention is to provide a light that can be secured to the pivotable lid of a cooler and which can provide light when the cooler is used in a dark environment.

A further object of this invention is to provide a durable and water tight light source which can be secured to the inside of a cooler lid and which can operate at low electrical power for an extended period of time.

Still another object of this invention is to provide a cooler with a relatively inexpensive light which utilizes light-emitting, semiconductor diodes.

Still further, an object of this invention is to provide a cooler with a light that can be turned on or off automatically as the lid is raised or lowered through a predetermined angle.

Other objects and advantages of the present invention will become more apparent to those skilled in the art in view of the following description and the accompanying drawings.

### BRIEF DESCRIPTION OF THE DRAWINGS

FIG. 1 is a perspective view of a cooler with a lid which contains a light that is activated as the lid is opened.

FIG. 2 is a cross-sectional view of a housing containing a printed circuit board having a power source, a tilt switch and multiple light-emitting, semiconductor diodes electrically connected to the printed circuit board.

FIG. 3 is a partial enlarged view of the connection between the first and second members shown in FIG. 2 and showing the water-tight seal which is positioned between the two members.

FIG. 4 is a front view of the housing shown in FIG. 2 taken along line 3-3.

FIG. 5 is a cross-sectional view of an alternative embodiment of a housing showing a second member friction fitted to a first member and showing a water-tight seal positioned within the first member and abutting an upper surface of the second member.

FIG. 6 is an exploded cross-sectional view of still another embodiment of a housing showing first and second members each have a cooperating thread formed therein and having a water-tight seal positioned adjacent to the thread formed in the first member.

FIG. 7 is a front view of the first and second members shown in FIG. 2 and taken along line 7-7 depicting the printed circuit board containing an electrical circuitry, the power source, the tilt switch and multiple lights.

FIG. 8 is a side view of the circular housing shown in FIG. 4 taken along line 8-8.

FIG. 9 is an alternative side view of the circular housing shown in FIG. 4 taken along line 9-9 showing an elongated strip of reflective film surrounding each of the multiple light-emitting, semiconductor diodes by 360 degrees.

### DETAILED DESCRIPTION OF THE INVENTION

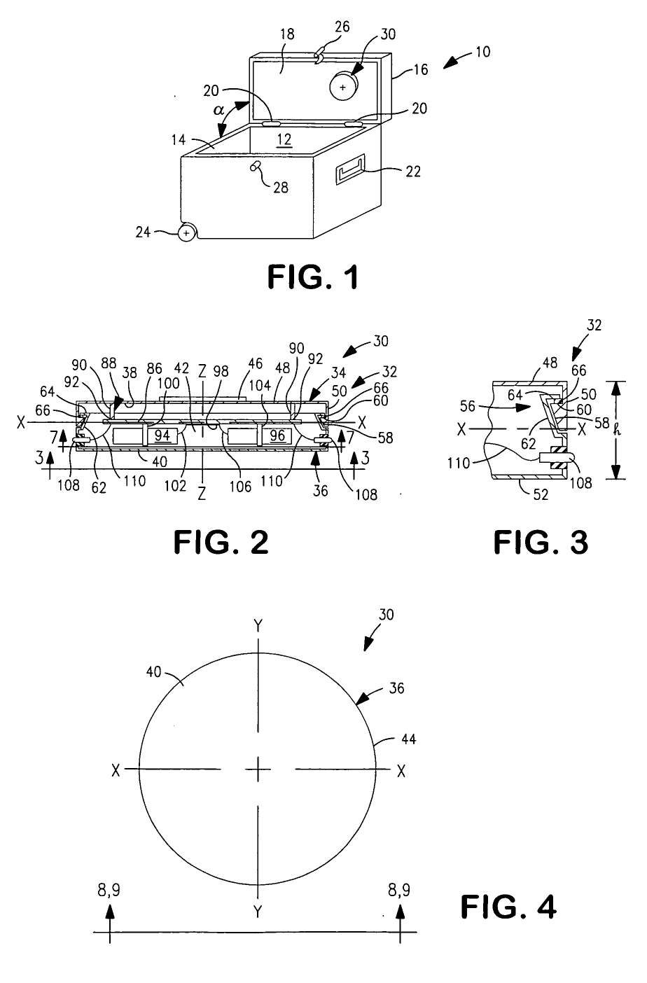

Referring to FIG. 1, a cooler 10 is shown formed from an insulating material. By “cooler” it is meant a device or container that cools or keeps items cold. The insulating material, not shown, can be any kind of material that will allow items stored in the cooler 10 to remain cold for a predetermined period of time. Polystyrene and styrene are two materials that can be used as the insulating material. Those skilled in the art are well aware of other materials that can also be used as insulating material. Polystyrene is a rigid clear thermoplastic polymer that can be molded into objects or made into a foam that can be used in insulation and packaging. Styrene is a monomer of polystyrene and has the chemical formula “C₆H₅CH:CH₂”.

The cooler 10 has a storage compartment 12 having a predetermined volume capacity. The storage compartment 12 has an enlarged opening 14 depicted as being the upper surface of the storage compartment in FIG. 1. The size, shape and overall profile of the cooler 10 can vary. In FIG. 1, the cooler 10 is depicted as a three-dimensional, rectangular box or chest. However, it is to be understood that the cooler 10 can have almost any desired profile. The cooler 10 can be constructed from a rigid material, a flexible material or from a combination of two materials, one rigid and one flexible. An example of a flexible material is nylon, and an example of a rigid material is a sheet of polystyrene encased in metal, plastic, wood, a composite material, etc. The cooler 10 can be sized to hold or retain various food items, including meat, fish, poultry, fruits, vegetables, potato salad, baked beans, ice cream, prepared dishes, desserts, etc. The cooler 10 can also retain various kinds of beverages, including but not limited to soft drinks, soda, pop, bottled water, beer, wine, wine coolers, alcoholic drinks, etc. The cooler 10 can also be filled with ice, dry ice or some other form of cooling or refrigeration mechanism. Typically, cubed, crushed or block ice is added to the contents stored in the cooler 10 to keep them cool or cold for several hours. Some coolers are sized to only retain a couple of items while others are made larger and can hold several cans of beer, soda or bottled water. Still others are several feet long by several inches width and several inches in depth and can hold a large quantity of supplies.

The cooler 10 includes a lid 16 which has an interior surface 18. The lid 16 is connected to the storage compartment 12 by one or more hinges 20 and is capable of pivoting between a closed position and an open position. In FIG. 1, two spaced apart hinges 20 are shown, each being coaxially aligned with one another. In FIG. 1, the lid 16 is depicted in the open position. In the open position, a person can insert, retrieve or both insert and retrieve items from the storage compartment 12 via the opening 14. When the lid 16 is in a closed position, the storage compartment 12 will close off and the lid 16 will seal the opening 14. For a rectangular shaped cooler 10, as depicted in FIG. 1, when the lid 16 is in a closed position, it will be horizontally aligned over the opening 14 and completely close off the storage compartment 12. In other words, the lid 16 can pivot from a closed, horizontal position to an open position wherein the lid 16 is angled a certain number of degrees from the closed position. The angle alpha α depicts the degrees or arc that the lid 16 can pivot through. The open position can range from between about 15 degrees to about 180 degrees from the closed position. Desirably, the open position ranges from between about 45 degrees to about 180 degrees from the closed position. More desirably, the open position ranges from between about 80 degrees to about 135 degrees from the closed position. Most desirably, the open position is at least about 90 degrees from the closed position.

It is to be understood that the closed position can be angled relative to the horizontal depending upon the overall shape and configuration of the cooler 10. For example, the closed position could be at 15 degrees to the horizontal and the open position is at a certain number of degrees as measured from the closed position.

Still referring to FIG. 1, one will notice that the cooler 10 includes one or more handles 22 and a pair of wheels 24, one of which is depicted, that can be utilized to pull, roll or transport the cooler 10 from one location to another. The handle 22 and the wheels 24 are optional. The cooler 10 can also contains a fastener 26 and a cooperating mechanism 28 so as to be able to lock or secure the lid 16 to the storage compartment 12. The fastener 26 and the cooperating mechanism 28 are also optional features. In FIG. 1, the fastener 26 is shown as a latch pivotably mounted to the lid 16 and the cooperating mechanism 28 is a stud extending outward from the exterior of the storage compartment 12. It should be understood by those skilled in the art that various types of fasteners 26 and cooperating mechanisms 28 and taken along line 7-7 can be utilized to hold the lid 16 secure to the storage compartment 12.

Referring to FIGS. 1-4, the cooler 10 also contains a light source 30 that is activated as the lid 16 is opened. The light source 30 includes a housing 32 that is shown constructed of a first member 34 and a second member 36. The housing 32 has a longitudinal central axis X-X, a transverse central axis Y-Y, and a vertical central axis Z-Z, see FIGS. 2-4. The housing 32 can be constructed as a single member or be constructed from two or more members. The housing 32 also has an interior surface 38, an exterior surface 40 and a void volume 42 located therebetween. The housing 32 can be formed from various materials including but not limited to: plastic, thermoplastics, composite materials, a ferrous metal, a non-ferrous metal, fiberglass, graphic, etc. Desirably, the housing 32 is formed from a thermoplastic material. The housing 32 can have any desired geometrical shape or configuration and can be constructed to any size dimensions. However, a smaller size is desired over a larger size. In FIG. 4, the housing 32 is depicted as being a circular disk having an outer periphery 44 with a diameter of less than about 4 inches and a height h of less than about 1.5 inches. Desirably, the housing 32 has a diameter of less than about 3.5 inches and a height h of less than about 1.25 inches. More desirably, the housing 32 has a diameter of less than about 3 inches and a height h of less than about 1 inch.

Referring again to FIGS. 2 and 3, a portion of the exterior surface 40 of the housing 32, namely the first member 34, is secured to the interior surface 18 of the lid 16. The exterior surface 40 can be secured to the interior surface 18 of the lid 16 using various mechanical or chemical fasteners known to those skilled in the art. Examples of mechanical fasteners include but are not limited to: one or more screws, bolts, nails, pins, studs, a screw and a nut, a bolt and a nut, a toggle bolt, VELCRO, tread, laces, etc. Examples of a chemical fastener include but are not limited to: an adhesive, glue, a liquid cement, epoxy, co-adhesive, etc. By an “adhesive” it is meant something that will adhere; that is sticky; that provides adhesion. By “glue” it is meant a strong liquid adhesive obtained by boiling collagenous animal parts such as bones, hides and hooves into hard gelatin and then adding water. By a “liquid cement” it is meant an adhesive material that can be applied as a liquid and which hardens to a solid at room temperature. By “epoxy” it is meant any of various thermosetting resins capable of forming tight, cross-linked polymer structures characterized by toughness, strong adhesion and low shrinkage. By “co-adhesive” it is meant an adhesive that has the ability to attach to itself.

As depicted in FIG. 2, an adhesive patch 46 is depicted which is positioned on an exterior surface of the first member 34. The adhesive patch 46 can be secure to the interior surface 18 of the lid 16. The adhesive patch 46 allows the housing 32 to be attached or secured to any portion of the interior surface 18 of the lid 16. However, for maximum illumination, the housing 32 should be attached at a location that is approximate the middle of the length of the lid 16 so as to provide light to the entire storage compartment 12.

Referring to FIGS. 2, 3, 5 and 6 the first member 34 includes a base 48 and a vertical portion 50 which extends downward from the base 48 at approximately a 90 degree angle. The first member 34 can be visualized as a soup bowl turned upside down. The base 48 of the first member 34 is adhesively secured to the interior surface 18 of the lid 16. The second member 36 also includes a base 52 having a vertical portion 54 which extends upward from the base 52 at approximately a 90 degree angle. The second member 36 can be visualized as a soup bowl turned right side up. The second member 36 is removably connected to the first member 34 by a mechanical mechanism 56, by a friction fit, by a screw thread, or by other means known to those skilled in the art. The mechanical mechanism 56 can be any type of attachment known to those skilled in the art. As depicted in FIGS. 2 and 3, the mechanical mechanism. 56 includes cooperating attachment structure formed or secured to the first and second members, 34 and 36 respectively. As depicted, the mechanical mechanism 56 includes a downwardly extending incline surface 58 with a shoulder 60 located above the inclined surface 58. The shoulder 60 is aligned horizontally and parallel to the longitudinal central axis X-X of the housing 32. Both the inclined surface 58 and the shoulder 60 are formed on an inner surface of the vertical portion 50 of the first member 34. The mechanical mechanism 56 also includes a flexible, tapered tongue 62 with an outwardly extending detent 64 located above the tapered tongue 62. The detent 64 is aligned horizontally and parallel to the longitudinal central axis X-X of the housing 32. Both the tapered tongue 62 and the detent 64 are formed on an outer surface of the vertical portion 54 of the second member 36. The tapered tongue 62 and the detent 64 fit over and cooperate with the incline surface 58 and the shoulder 60.

The second member 36 can be released from the first member 34 by depressing the tapered tongue 62 inward so that the detent 64 no longer resides on the shoulder 60.

FIGS. 2 and 3 also depict a water-tight seal or gasket 66 positioned vertically between the shoulder 60 and the detent 64. By “seal or gasket” it is meant a device that joins two elements together so as to prevent leakage; or any of a wide variety of seals or packings used between matched machined parts to prevent the escape of a gas or fluid. The seal 66 can be a circular ring having an outside diameter approximately equal to or slightly larger than the inside surface of the vertical portion 50 of the first member 34. The seal 66 can have an inside diameter which is equal to or less than the inside diameter of the shoulder 60. The water-tight seal or gasket 66 will prevent water and/or moisture from getting into the housing 32.

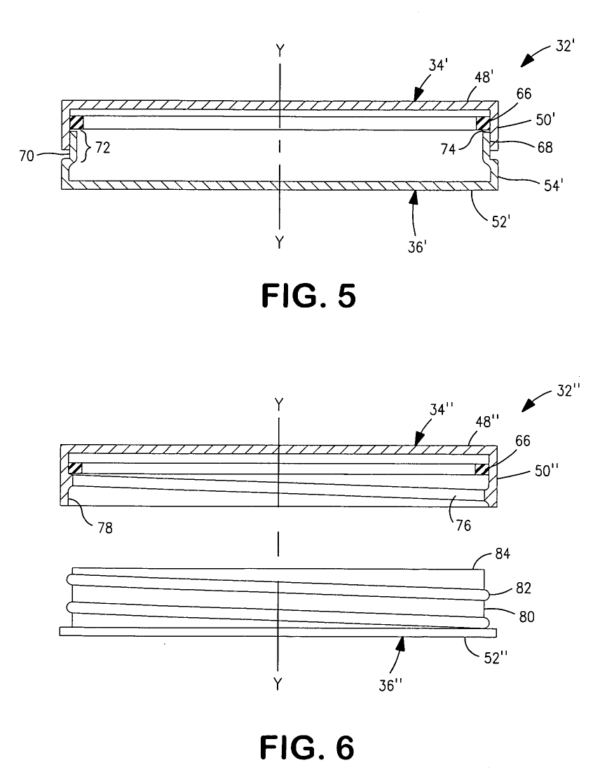

Referring now to FIG. 5, an alternative embodiment of a housing 32′ is depicted which includes a first member 34′ and a second member 36′. The second member 36′ is secured to the first member 34′ by a friction fit. In this arrangement, the first member 34′ again has a base 48′ with a vertical portion 50′ which extends downward from the base 48′ at approximately a 90 degree angle. The vertical portion 50′ has a relatively smooth inner surface 68 having a constant diameter. The second member 36′ also has a base 52′ having a vertical portion 54′ which extends upward from the base 52′ at approximately a 90 degree angle. The vertical portion 54′ has a stepped exterior surface 70 with an upper portion 72 which is slightly larger, by a few millimeters, than the inner surface 68 of the first member 34′. By pressing the second member 36′ onto the first member 34′ an interference or friction fit is obtained which will hold the first and second members, 34′ and 36′ respectively, snuggly together.

The housing 32′ also includes a water-tight seal or gasket 66 positioned within the first member 34′ and located above and adjacent to an upper end 74 of the second member 36′. The water-tight seal or gasket 66 will prevent water and/or moisture from getting into the housing 32′.

Referring to FIG. 6, a third embodiment of a housing 32″ is depicted which includes a first member 34″ and a second member 36″. The second member 36″ is secured to the first member 34″ by a spiral thread. In this arrangement, the first member 34″ again has a base 48″ with a vertical portion 50″ which extends downward from the base 52″ at approximately a 90 degree angle. The vertical portion 50″ has an interior surface 78 with a spiral thread 76 formed thereon. The second member 36″ also has a base 52″ having a vertical portion 54″ which extends upward from the base 52″ at approximately a 90 degree angle. The vertical portion 54″ has an exterior surface 80 with a spiral thread 82 formed thereon which is sized and configured to engage with the spiral thread 76. By threading the spiral thread 82 onto the spiral thread 76, the second member 36″ can be securely connected to the first member 34″. By unthreading the second member 36″ from the first member 34″, the two members 34″ and 36″ can be separated from one another.

The housing 32″ also includes a water-tight seal or gasket 66 positioned within the first member 34″ and located above and adjacent to an upper end 84 of the second member 36″ when the second member 36″ is threaded onto the first member 34″. The water-tight seal or gasket 66 will prevent water and/or moisture from getting into the housing 32″.

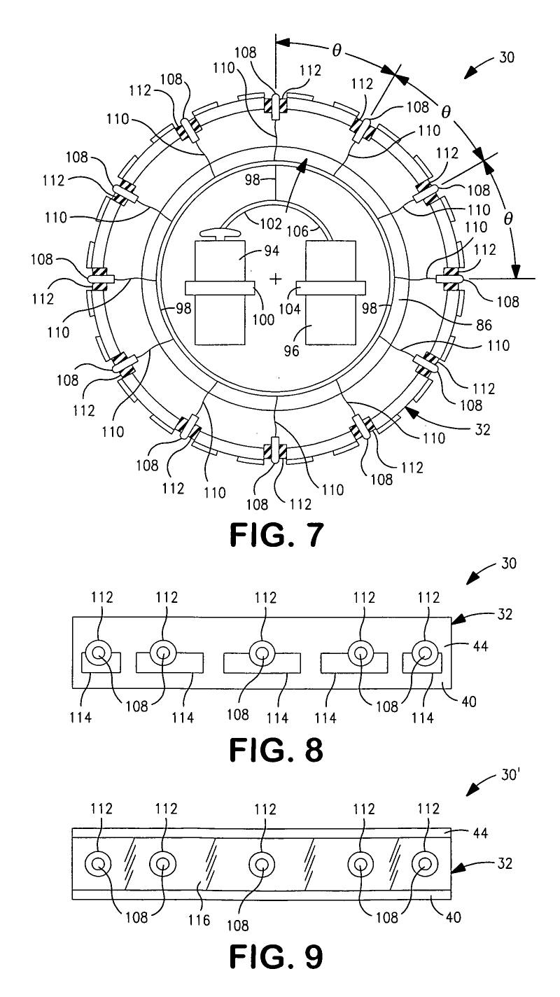

Referring now to FIGS. 2 and 7, the light source 30 includes a printed circuit board 86 positioned in the void volume 42 of the housing 32. The printed circuit board 86 is secured to the interior surface 38 of the housing 32 and positioned at an appropriate location by an attachment mechanism 88. The attachment mechanism 88 can vary in shape, size, construction, etc. Various attachment mechanisms 88 are well known to those skilled in the art. For example, the attachment mechanism 88 in FIG. 2 includes a pair of spaced apart abutments 90 integrally formed on the interior surface 38 of the first member 34. Each of the pair of abutments 90 extends downward and parallel to the vertical central axis Z-Z towards the second member 36. The pair of abutments 90 can range from 0.125 inches to about 0.75 inches in length. An adhesive 92 can be used to secure the printed circuit board 86 to the ends of the pair of abutments 90.

It should be understood by those skilled in the art that one or more abutments 90 can be utilized and that the size, shape and arrangements of the abutments 90 can vary to suit one's specific needs and requirements.

The printed circuit board 86 includes a power source 94, a tilt switch 96, and an electrical circuit 98 connecting the power source 94 to the tilt switch 96. The power source 94 can be a standard alkaline battery or an alkaline-manganese dioxide battery, both commercially sold by Duracell USA, a division of Duracell, Inc. having an office at Berkshire Corporate Park, Bethel, Conn. 06801; or by Varta Consumer Batteries Gmbh & Co. KGaA, Alfred-Krupp Str. 9, 73479 Ellwangen, Germany.

The battery capacity of alkaline-manganese dioxide batteries available at most retail stores in the United States is as follows:

| Battery Type | Capacity (mAh) | Typical Drain (mA) |
|---|---|---|
| D | 12,000 | 2 |
| C | 6,000 | 100 |
| AA | 2,000 | 50 |
| AAA | 1,000 | 10 |
| N | 650 | 10 |
| 9 volt | 500 | 15 |
| 6 volt Lantern | 11,000 | 300 |

The battery capacity will be better with lower drain currents. To determine the battery life, divide the capacity by the actual load current to get the hours of life. A circuit that draws 10 ma powered by a 9 volt rectangular battery will operate about 50 hours: 500 mAh/10 mA=50 hours. The cell voltage of alkaline cells steadily drops with usage from 1.54 volts to about 1 volt when discharged. The voltage is near 1.25 volts at the 50% discharge point. Alkaline cells exhibit a slightly increased capacity when warmed and the capacity drops significantly at temperatures below freezing. Mercury and silver oxide batteries have nearly twice the capacity as alkaline batteries of the same size but the current rating are significantly lower. Alkaline batteries also have good shelf life making them ideal for home-made electronic projects. Rechargeable batteries have less capacity than primary cells as shown in the following chart. This chart shows the capacity as a percentage of the capacity of an alkaline battery with the same dimensions.

CHART 1

| Battery Type | % Capacity |
|---|---|
| Lead-acid | 35 |
| Nickel-cadmium | 30 |
| Silver-zinc | 85 |

The power source 94 can also use other kinds of batteries, including but not limited to: lead acid, lithium, lithium ion, nickel zinc, nickel cadmium, nickel manganese, nickel metal hydride, zinc carbon, etc. The power source 94 can be held secure to the printed circuit board 86 by a battery holder 100 and can be connected to the electrical circuit 98 by a battery lead 102. Various models of the battery holder 100 and the battery lead 102 are available from Ningbo Best Group factory having an office at Jiangdong, Ningbo City, Zhejiang Province, China.

Alternatively, the power source 94 can be a solar panel (not shown) mounted on an exterior surface of the cooler 10, mounted to the exterior surface of the lid 16 or mounted to the exterior surface of both the cooler 10 and the lid 16.

The tilt switch 96 can be a photo interrupter switch such as are commercially available from NKK Switches having an e-mail address of sales@nkkswitches.com and a phone number of (480) 991-0942. The DSB model tilt switches utilize internal steel ball movement to turn the switch on and off. The tilt switch 96 can be constructed such that it is triggered when tilted plus or minus about 10 degrees or more. For example, the tilt switch 96 can be triggered from an “off” position to an “on” position with movement through at least about 10 degrees. When the tilt switch 96 is triggered, the light source 30 will be turned on. The tilt switch 96 can be tilted through increasing number of degrees while keeping the light source 30 on. For example, a tilt switch 96 can have an operating range of “on” from about 10 degrees to about 170 degrees, and an “off” angle of from about 190 degrees to about 350 degrees. As the tilt switch 96 is tilted back again towards it original position, the light source 30 will turn “off” once the tilt switch 96 again passes through the angle of about 10 degrees. The angle at which the tilt switch 96 is triggered can be varied to suit one's specific requirements. For example, the tilt switch 96 can be set to be trigger to the “on” position once the tilt switch 96 moves pass 10 degrees, 15 degrees, 20 degrees, 45 degrees, 90 degrees, etc. Such tilt switches 96 can be a single pole, single throw on-off switch.

The tilt switch 96 can be secured to the printed circuit board 86 by a holder 104. The holder 104 can be constructed in various shapes and can be sized to fit the particular model tilt switch 96 that one desires to use. The tilt switch 96 can be connected to the electrical circuit 98 by an electrical lead 106.

Still referring to FIG. 7, the light source 30 further includes a light 108 connected to the electrical circuit 98 by an electrical lead 110. In FIG. 7, twelve lights 108 are depicted. It should be understood that any number of lights 108 can be utilized. Desirably, the number of lights 108 can range from between 1 to about 1,000 lights. More desirably, the number of lights 108 can range from between 2 to about 100 lights. Even more desirably, the number of lights 108 can range from between 3 to about 50 lights. Each light 108 protrudes through the exterior surface 40 of the housing 32. The lights 108 can be spaced apart from one another by a predetermined number of degrees or by a set dimension. For example, in FIG. 7, the twelve lights 108 are spaced 30 degrees from one another. The specific angle theta θ separating two adjacent lights 108 can vary from a fraction of a degree to 360 degrees. With multiple lights 108 situated about at least a portion of the outer periphery 44 of the housing 32, each light 108 can be spaced about 5, 10, 15, 20 or more degrees apart. Desirably, the lights 108 are spaced completely around the entire outer periphery 44 of the housing 32. It should also be understood that the lights 108 can be grouped or clustered in certain areas of the outer periphery 44 of the housing 32 such that they are not evenly spaced apart. In some applications, it may be advantageous to position the lights 108 to shin over an arc ranging from 1 degree to about 90 degrees. In this case, the remainder of the outer periphery 44 of the housing 32 does not need to have any lights 108 protruding therefrom.

As depicted in FIG. 7, each of the twelve lights 108 protrudes through the outer periphery 44 of the housing 32. Each light 108 can be a conventional light bulb or be light-emitting, semiconductor diode (LED). Desirably, each light 108 is an LED. By a “light-emitting diode (LED)” it is meant a semiconductor diode that emits incoherent narrow-spectrum light when electrically biased in the forward direction of the p-n junction. This effect is a form of electroluminescence. An LED is usually a small area source, often with extra optics added to the chip that shapes its radiation pattern. The color of the emitted light depends on the composition and condition of the semiconducting material used, and can be infrared, visible, or near-ultraviolet. An LED can be used as a regular household light source.

Like a normal diode, an LED consists of a chip of semiconducting material impregnated, or doped, with impurities to create a p-n junction. As in other diodes, current flows easily from the p-side, or anode, to the n-side, or cathode, but not in the reverse direction. Charge carriers—electrons and holes—flow into the junction from electrodes with different voltages. When an electron meets a hole, it falls into a lower energy level and releases energy in the form of a photon.

The wavelength of the light emitted, and therefore its color, depends on the band gap energy of the material forming the p-n junction. In silicon or germanium diodes, the electrons and holes recombine by non-radiative transition which produces no optical emission because these are indirect band gap materials. The materials used for an LED have a direct band gap with energies corresponding to near-infrared, visible or near-ultraviolet light.

Conventional LED's are made from a variety of inorganic semiconductor materials which produce the following colors:
1. Aluminium gallium arsenide—red and infrared;
2. Aluminium gallium phosphide—green;
3. Aluminium gallium indium phosphide—high brightness orange—red, orange, yellow and green;
4. Gallium arsenide phosphide—red, orange—red, orange and yellow;
5. Gallium phosphide—red, yellow and green;
6. Gallium nitride—green, pure green (or emerald green), and blue;
7. Indium gallium nitride—near ultraviolet, bluish-green and blue;
8. Silicon carbide—blue;
9. Silicon—blue;
10. Sapphire—blue;
11. Zinc selenide—blue;
12. Diamond—ultraviolet; and
13. Aluminium nitride, aluminium gallium nitride, aluminium gallium indium nitride—near to far ultraviolet (down to 210 nm.)

It should be understood that a combination of red, green and blue LED's can produce the impression of white light, though white LED's today rarely use this principle. Most “white” LED's in production today are modified blue LED's: GaN-based, InGaN-active-layer LED's emit blue light of wavelengths of between 450 nm and 470 nm. Desirably, the light-emitting diodes 108 are constructed so as to produce a white color or a blue color. More desirably, the light-emitting diodes 108 will be able to emit a white color.

Still referring to FIG. 7, each light 108 can be a light-emitting, semiconductor diode having a predetermined light refractive index. Each light 108 is circumferentially surrounded by a packing material 112. The packing material 112 can be formed from a variety of materials which can function to establish a water-tight or water-proof seal between each light 108 and the housing 32. For example, the packing 112 can be a grommet. In addition, the packing material 112 can be formed from a material that has a light refractive index which matches the light refractive index of each light emitting diode 108. Alternatively, the packing material 112 can be coated or covered with a material that has a light refractive index which matches the light refractive index of each light emitting diode 108. This features helps illuminate the light given off by the light(s) 108.

Referring now to FIG. 8, the light source 30 is shown along with a portion of the outer periphery 44 of the housing 32. Multiple light-emitting diodes 108 are depicted each at least partially surrounded by a light reflective film 114. The light reflective film 114 enhances the illumination from each of the multiple lights 108. The light reflective films 114 can be secured to a portion of the exterior surface 40 of the housing 32.

Referring to FIG. 9, a light source 30′ is shown along with a portion of the outer periphery 44 of the housing 32. Multiple light-emitting diodes 108 are depicted each surrounded 360 degrees by an elongated strip of light reflective film 116. The elongated strip of light reflective film 116 completely surrounded each of the lights 108 and enhances the illumination from each of the multiple lights 108. The elongated strip of light reflective film 116 can be secured to a portion of the exterior surface 40 of the housing 32.

Returning to FIG. 1, as the lid 16 is raised through a set angle, say 10 degrees, from its horizontal closed position covering the storage compartment 12, the tilt switch 96 will cause an electrical connection to be made which will allow the power source 94 to provide electrical current to the electrical circuit 98 such that each of the lights 108 will be illuminated. This means that as the lid 16 is flipped open 90 degrees or more, the light from the multiple lights 108 will illuminate the inside of the storage compartment of the cooler 10 and allow a person to see what item he or she wishes to remove. Alternatively, the light source 30 will allow a person to rearrange the items in the storage compartment 12 of the cooler 10 or to insert additional items into the cooler 10. The illumination from the light source 30 should be sufficiently bright to allow a person to identify the items in the storage compartment 12 of the cooler 10 when in a low light or dark environment.

While the invention has been described in conjunction with several specific embodiments, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A cooler formed from an insulating material, comprising:
a) a storage compartment having a predetermined volume capacity;
b) a lid having an interior surface, said lid being connected to said storage compartment and capable of pivoting between a closed position and an open position, said open position being angled at least about 90 degrees from said closed position;
c) a housing having an interior surface, an exterior surface and a void volume therebetween, and a portion of said exterior surface of said housing being secured to said interior surface of said lid;
d) a printed circuit board positioned in said void volume and secured to said interior surface of said housing, said printed circuit board including a power source, a tilt switch and an electrical circuit connecting said power source to said tilt switch; and
e) a light connected to said electrical circuit and protruding through said exterior surface of said housing, wherein as said lid is raised a predetermined number of degrees from said closed position, said tilt switch causes said light source to turn on to illuminate said storage compartment of said cooler.

2. The cooler of claim 1 wherein said housing includes a first member and a second member, said first member being adhesively secured to said interior surface of said lid, and said second member being removably connected to said first member by a mechanical mechanism.

3. The cooler of claim 2 wherein a water-tight seal is formed between said first and second members.

4. The cooler of claim 1 wherein said light is a light-emitting, semiconductor diode having a predetermined light refractive index, and a packing material circumferentially surrounding said light-emitting diode, said packing material having a light refractive index which matches said light refractive index of said light-emitting diode.

5. The cooler of claim 4 wherein said housing is constructed from a thermoplastic material and is a circular disk having an outer periphery with a diameter of less than about 4 inches and a height of less than about 1.5 inches, and multiple light-emitting diodes protrude through said exterior surface of said housing.

6. The cooler of claim 5 wherein each of said multiple light-emitting diodes are spaced at least 20 degrees apart from one another about at least a portion of said outer periphery of said housing.

7. The cooler of claim 6 wherein each of said multiple light-emitting diodes is at least partially surrounded by a light reflective film and said light reflective film is secured to a portion of said exterior surface of said housing.

8. The cooler of claim 7 wherein each of said multiple light-emitting diodes is surrounded 360 degrees by said light reflective film.

9. The cooler of claim 1 wherein said lid is in a closed position when it is horizontally positioned over said storage compartment and as said lid is pivotably lowered from said open position to at least about 10 degrees from said closed position, said tilt switch causes said light to turn off and stops illuminating said storage compartment of said cooler.

10. A cooler formed from an insulating material, comprising:
a) a storage compartment having a predetermined volume capacity;
b) a lid having an interior surface, said lid being connected to said storage compartment and capable of pivoting between a closed position and an open position, said open position being angled at least about 90 degrees from said closed position;
c) a housing having an interior surface, an exterior surface, an outer periphery, and a void volume situated within said interior surface, and a portion of said exterior surface being secured by an adhesive to said interior surface of said lid;
d) a printed circuit board positioned in said void volume and secured to said interior surface of said housing, said printed circuit board including a power source, a tilt switch and an electrical circuit connecting said power source to said tilt switch;
e) multiple lights connected to said electrical circuit and each protruding through said exterior surface of said housing, each of said multiple lights being evenly spaced apart from one another about at least a portion of said outer periphery, wherein as said lid is raised at least about 10 degrees from said closed position said tilt switch causes each of said multiple lights to turn on to illuminate said storage compartment of said cooler; and
f) a reflective film secured to a portion of said outer periphery and positioned adjacent to each of said multiple lights to enhance illumination.

11. The cooler of claim 10 wherein each of said multiple lights is a light-emitting, semiconductor diode having a predetermined light refractive index and each of said light-emitting diodes being circumferentially surrounded by a packing material which has a light refractive index which matches said light refractive index of each of said light-emitting diodes.

12. The cooler of claim 11 wherein each of said multiple light-emitting diodes is spaced at least about 15 degrees apart from one another about said outer periphery, and each of said multiple light-emitting diodes produces a white color.

13. The cooler of claim 11 wherein each of said multiple light-emitting diodes is spaced at least about 10 degrees apart from one another about said outer periphery, and each of said multiple light-emitting diodes produces a blue color.

14. The cooler of claim 10 wherein said housing includes a first member and a second member, said first member being secured to said interior surface of said lid, and said second member being removably connected to said first member by a friction fit and a water-tight seal.

15. The cooler of claim 10 wherein said housing includes a first member and a second member, said first member having a thread and being secured to said interior surface of said lid, and said second member having a thread and being removably threaded onto said first member and forming a water-tight seal therewith.

16. A cooler formed from an insulating material, comprising:
a) a storage compartment having a predetermined volume capacity;
b) a lid having an interior surface, said lid being connected to said storage compartment and capable of pivoting between a closed horizontal position and an open position, said open position being angled at least about 90 degrees from said closed position;
c) a housing having an interior surface, an exterior surface, an outer periphery, and a void volume situated within said interior surface, and a portion of said exterior surface being secured by an adhesive to said interior surface of said lid;
d) a printed circuit board positioned in said void volume and secured to said interior surface of said housing, said printed circuit board including a power source, a tilt switch and an electrical circuit connecting said power source to said tilt switch;
e) multiple light-emitting, semiconductor diodes also connected to said electrical circuit and protruding through said exterior surface of said housing, each of said multiple light-emitting, semiconductor diodes being evenly spaced apart from one another about said outer periphery, wherein as said lid is raised at least about 10 degrees from said closed horizontal position said tilt switch causes each of said multiple light-emitting, semiconductor diodes to turn on to illuminate said storage compartment of said cooler; and
f) a reflective film secured to a portion of said outer periphery and positioned adjacent to each of said multiple light-emitting, semiconductor diodes to enhance said illumination.

17. The cooler of claim 16 wherein each of said multiple light-emitting, semiconductor diodes has a predetermined light refractive index and each is circumferentially surrounded by a packing material which has a light refractive index which matches said light refractive index of each of said multiple light-emitting, semiconductor diodes.

18. The cooler of claim 16 wherein each of said multiple light-emitting semiconductor diodes is surrounded 360 degrees by said light reflective film.

19. The cooler of claim 16 wherein said housing includes a first member and a second member, said first member being mechanically secured to said interior surface of said lid, said second member being removably connected to said first member by a mechanical mechanism and said first and second members forming a water-tight seal therebetween.

20. The cooler of claim 19 wherein said housing is constructed from a thermoplastic material and said housing is a circular disk having an outer periphery with a diameter of less than about 3 inches and a height of less than about 1 inch.
